(19) United States
(12) Patent Application Publication
(10) Pub. No.: US 2007/0180641 A1
(43) Pub. Date: Aug. 9, 2007

(54) Hand tool assembled using tape

(75) Inventor: Carl A. Bongiovanni, Gibsonia, PA (US)

Correspondence Address: THE LAW OFFICE OF RICHARD W. JAMES, 25 CHURCHILL ROAD, CHURCHILL, PA, 15235, US

(73) Assignee: Bon Tool Company

(21) Appl. No.: 11/347,958

(22) Filed: Feb. 6, 2006

(51) Int. Cl. E01C 19/22; B05C 17/10

(52) U.S. Cl. 15/235.4; 404/118

(57) ABSTRACT

A hand tool comprising a finishing element and a handle, wherein the finishing element is affixed to the handle with adhesive tape, and a method of affixing a handle to a finishing element using adhesive tape. A bracket may be used intermediate the finishing element and the handle.

### BACKGROUND OF THE INVENTION

Certain construction tools, such as masonry and concrete finishing hand tools and drywall and plaster finishing hand tools, include a handle and finishing element such as a blade, bit, or shaping element. The handle typically has a finishing element coupling surface used to attach the handle to the finishing element and a hand grip for holding the tool. The finishing element typically has an operating surface that moves, shapes, or otherwise contacts a material during operation and a handle coupling surface, often opposite the operating surface. For example, a trowel may include a handle affixed to a blade for placing, smoothing or otherwise shaping unhardened mortar, concrete, or other materials. Other tools, often those having extended handles, include a handle coupling bracket coupled to the handle coupling surface of a finishing element. An extended handle may then be coupled to the bracket.

Such handles and handle coupling brackets are often coupled to the handle coupling surface of the finishing element using rivets. Those rivets generally extend through the finishing element and are exposed in the operating surface of the finishing element. Such rivets tend to create ridges or bumps or other undesirable imperfections in the operating surface.

In certain applications, for example where the handle coupling surface of the finishing element is not flat, an intermediate plate is riveted to the finishing element and the handle or handle coupling bracket is attached to the intermediate plate. The handle or handle coupling element is typically coupled to the intermediate plate by rivets or screws.

Riveting also tends to be a time consuming operation. In a typical riveting process, holes are drilled through the finishing element and the handle, handle coupling bracket, or intermediate plate. The operating surface of the finishing element is sometimes countersunk at each hole to prevent the rivet from extending past the operating surface. Rivets are then placed through the holes and set. Smoothing or finishing is then often performed on the rivet and the operating surface where the rivet contacts the coupling surface to smooth that surface. Even after smoothing or finishing, however, the operating surface may be irregular.

Where the finishing element is sheet metal, the finishing element may be welded to a sheet metal intermediate plate and the intermediate plate may be attached to a handle by rivets or screws. Welding may also be time consuming, may involved expensive equipment, and typically involves smoothing or finishing on the operating surface and may, nonetheless, result in an irregular operating surface.

It has also been proposed that a trowel may have its handle bonded to a trowel blade by way of a curable epoxy-based adhesive and a strip located between the trowel blade and the handle. The strip proposed includes a plurality of studs stud welded to the strip for securing the strip to a flange by inserting the studs into holes in the flange and squashing and grinding the stud heads into the base portion of a support. Such a process has apparently not, however, been successfully commercialized.

Using epoxy alone to couple a handle to a trowel blade is time consuming and costly because epoxy use is generally time consuming and labor intensive. For example, epoxy may be used in a liquid form by mixing epoxy resin with a hardener, applying the epoxy to one or both surfaces to be bonded, and holding the pieces to be attached together for a significant period of time until the epoxy cures. Alternately, epoxy may be applied in solid form to surfaces to be bonded. When using solid for epoxy, heat is typically applied to the epoxy to liquefy or soften the epoxy and the pieces are held together for a significant period of time until the epoxy cures.

Using epoxy also has the drawback that it may not retain its shape and so may be thicker at some points such that the handle moves relative to the blade during affixation and becomes misaligned. Epoxy use may also require the extra steps of reshaping the epoxy after curing or wiping away excess epoxy “run-off” where the epoxy is displaced onto the handle or blade when the handle and blade are compressed against the epoxy.

Thus, there may be a need for a hand tool having a handle attached to a finishing element in a way that does not require smoothing or finishing. There may also be a need for a masonry hand tool having a handle attached to a finishing element in a way that does not impinge upon the operating surface of the finishing element. There may furthermore be a need for a masonry hand tool having a handle attached to a finishing element in a way that does not require use of expensive equipment. There may also be need for methods of attaching handles and handle coupling brackets to finishing elements such that no fastener impinges on the operating surface of the finishing element, and that is less time consuming and requires less expensive equipment than current methods.

### SUMMARY OF THE INVENTION

The present invention includes a hand tool comprising a finishing element and a handle, wherein the finishing element is affixed to the handle with adhesive tape.

The present invention also includes a method of affixing a handle to a hand tool using adhesive tape.

### BRIEF DESCRIPTION OF THE DRAWINGS

The detailed description is better understood in conjunction with the accompanying drawings, in which like reference characters represent like elements, as follows:

FIG. 1 is an isometric view of a groover in an embodiment of a hand tool assembled using tape;

FIG. 2 is a rear view of the groover of FIG. 1;

FIG. 3 is a sectional side view of the groover of FIGS. 1 and 2 cut along the length of the bit;

FIG. 4 is a top view of the groover of FIGS. 1-3 prior to attachment of a handle;

FIG. 5 is a sectional side view of another embodiment of a groover assembled using tape cut along the length of the bit;

FIG. 6 is a top view of the groover of FIG. 5 prior to attachment of a handle;

FIG. 7 is a sectional side view of another embodiment of a groover assembled using tape cut along the length of the bit;

FIG. 8 is a top view of the groover of FIG. 7 prior to attachment of a handle;

FIG. 9 is a rear view of a groover having a handle bracket and a detachable bracket assembled using tape;

FIG. 10 is a top view of the groover of FIG. 9 prior to attachment of the handle bracket;

FIG. 11 is a sectional side view of the groover of FIGS. 9 and 10;

FIG. 12 is a side view of a flying groover;

FIG. 13 is a top view of the flying groover of FIG. 12;

FIG. 14 is a front view of the flying groover 14 of FIGS. 12 and 13;

FIG. 15 illustrates another embodiment of a concrete-finishing tool;

FIG. 16 is a front view of an embodiment of an edger;

FIG. 17 is a sectional side view of the edger of FIG. 16 cut along the center of the two outer handle brackets;

FIG. 18 is a top view of the edger of FIGS. 16 and 17 prior to attachment of a handle;

FIG. 19 is a front view of an embodiment of another edger;

FIG. 20 is a sectional side view of the edger of FIG. 19 cut along the center of the two handle brackets;

FIG. 21 is a top view of the edger of FIGS. 19 and 20 prior to attachment of a handle;

FIG. 22 is an isometric view of a mortar joint finishing tool in an embodiment of a hand tool assembled using tape;

FIG. 23 is a side view of the mortar joint finishing tool of FIG. 22;

FIG. 24 is an end view of the mortar joint finishing tool of FIGS. 22 and 23;

FIG. 25 is a top view of the mortar joint finishing tool of FIGS. 22-24;

FIG. 26 is a top view of a trowel in an embodiment of a hand tool assembled using tape;

FIG. 27 is an end view of the trowel of FIG. 26;

FIG. 28 is a side view of a float in an embodiment of a hand tool assembled using tape;

FIG. 29 is an end view of the float of FIG. 28; and

FIG. 30 is a side view of another trowel in an embodiment of a hand tool assembled using tape.

### DETAILED DESCRIPTION

Reference will now be made to embodiments of hand tools assembled using tape and methods of assembling hand tools using tape, examples of which are illustrated in the accompanying drawings. Details, features, and advantages of the hand tools and methods of assembling hand tools will become further apparent in the following detailed description of embodiments thereof.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification do not necessarily all refer to the same embodiment. References to “or” are furthermore intended as inclusive, so “or” may indicate one or another of the ored terms or more than one ored term.

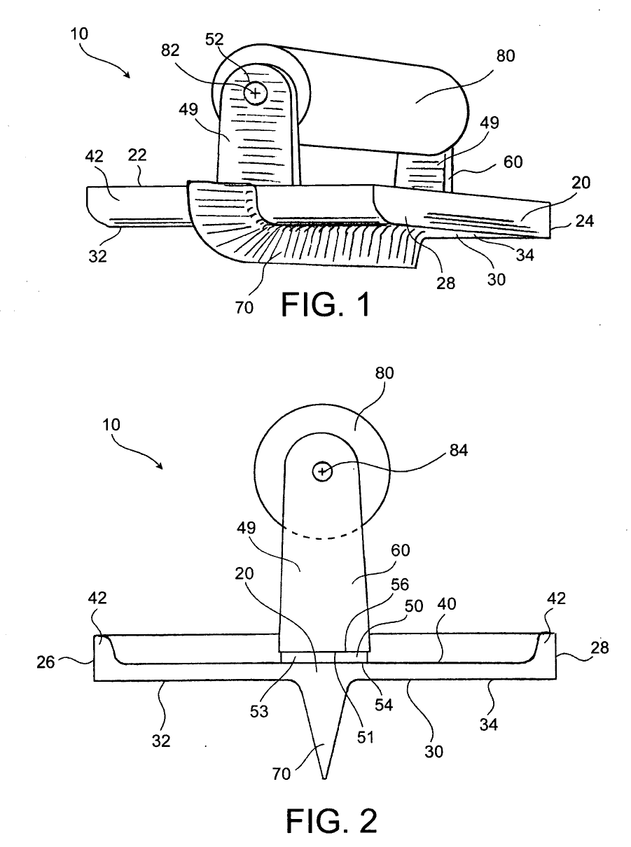

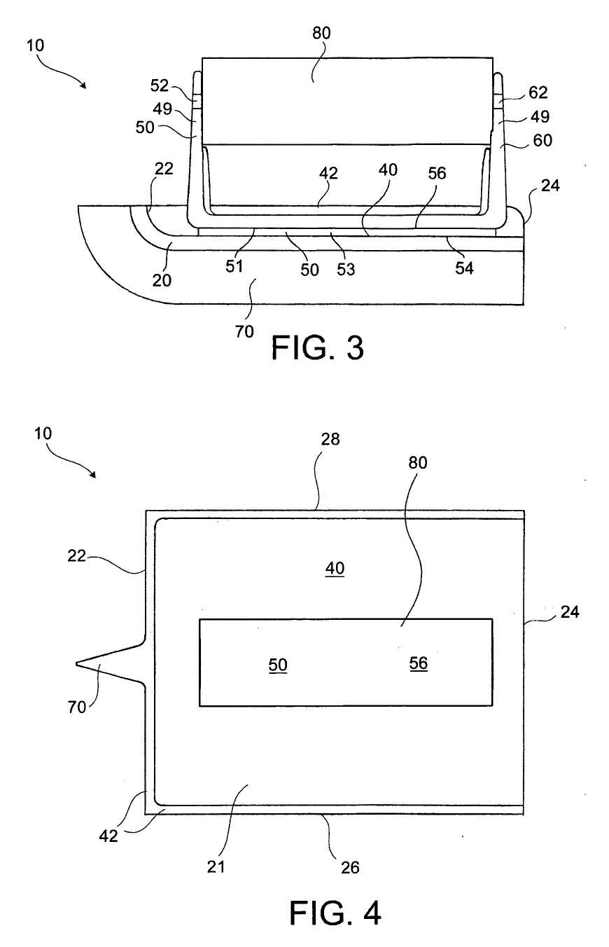

FIGS. 1-4 illustrate views of an embodiment of a hand tool having a handle coupled to a finishing element by double-sided tape. FIG. 1 is an isometric view of a groover 10 that may be used to place a grooved depression in concrete. FIG. 2 is a rear view of the groover 10, FIG. 3 is a sectional side view of the groover 10 cut along the length of a bit 70, and FIG. 4 is a top view of the groover 10 with double-sided tape applied to a handle coupling surface prior to attachment of a handle bracket 49 and a handle 80.

The groover 10 of FIGS. 1-4 includes a unitary finishing element, here a body 20 that includes a bit 70 for grooving. The bit 70 in this embodiment is formed on an operating surface, here a bottom face 30 of the body 20. The handle bracket 49 is affixed by double-sided tape 50 to a handle coupling surface, here a top face 40 of the body 20.

The body 20 in this embodiment also includes a front edge 22 and a back edge 24, a first side 26 and a second side 28. The top face 40 may be generally flat and parallel to the bottom face 30, or shaped differently as desired to create a surface appropriately shaped for application of double-sided tape and attachment of the handle bracket 49. The bottom face 30 may include guiding portions 32 and 34, for guiding the groover 10 along a concrete surface during use. The guiding portions 32 and 34 may be flat and coplanar, or configured differently to create a desired shape in concrete or other material to which the groover 10 is applied. The top face 40 may include a projecting portion 42 to improve the sturdiness of the body 20. That projecting portion 42 may extend along the first side 26, the front edge 22, and the second side 28 as in the embodiment illustrated in FIGS. 1-4.

The bit 70 may extend along the bottom face 30 between the guiding portions 32 and 34. In the embodiment illustrated in FIGS. 1-4, the bit 70 extends from near or at the back edge 24 to and past the front edge 22.

The handle bracket 49 is affixed to the top face 40 of the body 20 of the groover 10 by double-sided tape 50. The handle bracket 49 may include apertures 52 and 62 through which a handle 80 may be fastened by screws 82 and 84. Alternatively, apertures 52 and 62 and screws 82 and 84 may be replaced by other fastening means. Finishing elements, handles, handle brackets and various tool components to be affixed using double-sided tape 50 may be made from various materials including, for example, various metals, plastics, rubbers, woods or other desired materials or combinations of materials. Those finishing elements, handles, handle brackets and various tool components to be affixed using double-sided tape 50 may furthermore be formed by casting, extrusion, in sheet form, any combination thereof or as otherwise desired. The handle 80 may be made of wood, plastic, rubber, or any material or combination of materials desired.

The double-sided tape 50 includes a flexible substrate 53 with an adhesive situated on each side of the substrate 54 and 56. The double sided tape may be, for example, viscoelastic acrylic foam bonding tape, such as VHB™ Tape manufactured by 3M™.

The double-sided tape 50 may include a peal-off layer on one or both adhesive sides 54 and 56 to prevent the adhesive sides from sticking to anything until it is applied to a desired surface. One adhesive surface 54 may be exposed so that adhesive surface 54 may be applied to a first mating surface of a first mating piece. The first mating surface may be, for example, the handle coupling surface of the finishing element, the finishing element coupling surface of the handle, or a surface of an intermediate plate. The peal-off layer covering the second adhesive surface 56 of the double-sided tape 50 may then be removed and a second mating surface of a second mating piece may be placed on that second adhesive surface. The second mating surface may, for example, be the handle coupling surface of the finishing element, the finishing element coupling surface of the handle, a surface of an intermediate plate, or any part desired to be attached to the first mating surface.

For example, the first adhesive surface 54 of the double-sided tape 50 may be applied to the top face 40 of the groover 10 illustrated in FIGS. 1-4. A peal-off layer or other coating may then be removed from the second adhesive surface 56 of the adhesive tape 50 and the finishing element surface 51 of the handle bracket 49 may be placed on the second adhesive surface 56 of the adhesive tape 50.

The adhesion process may be completed by applying pressure to the mating surfaces by rolling or platen, for example. In an example wherein certain double-sided tapes are used, a pressure of approximately 15 pounds per square inch (psi) may be applied so as to press the two adjoining surfaces onto the adhesive sides 54 and 56 of the double-sided tape 50 and thereby couple those surfaces to the double-sided tape 50. That pressure may be applied once or repeatedly by, for example, a hydraulic press.

The surfaces may be prepared for attachment by double-sided tape 50 with relative ease. The surfaces may be generally cleaned of dirt and significant liquid or solid material that could prevent the double-sided tape 50 from adhering to the surface. Certain surfaces, such as wood, may be sealed prior to application of the double-sided tape 50. Other surfaces, such as plastic or painted surfaces, may benefit from preparatory processes to promote adhesion. It is generally beneficial for the surface to be shaped to meet, to the greatest extent possible, along the place where the double-sided tape 50 will be applied. Surfaces, however, generally need not be perfectly smooth, may be porous or non-porous in varying degrees, and may be curved or flat because double-sided tape 50 or the substrate 53 of the double sided-tape may be flexible or compressible. The flexibility or compressibility of the double-sided tape 50 or substrate 53 may assist the double-sided tape 50 to conform to the surfaces and increase contact of the adhesives with the surfaces.

The double-sided tape 50 may fill irregularities and gaps in the surfaces and may also seal the space between the surfaces. For example, double-sided tapes 50 may be formed with a strong, flexible, compressible substrate 53 that can mold to imperfect surfaces. Such a strong, flexible substrate 53 may further dampen vibrations, potentially making use of the tool more comfortable and safer for the user, may have good impact and shock resistance, and may resist fatigue and failure at the adjoining surfaces. The strong, flexible, compressible substrate 53 may also be beneficial when adhering surfaces made of differing materials that have different expansion and contraction characteristics because the substrate 53 may flex to a degree that could cause other fasteners to fail. Use of double-sided tape 50 to affix a tool handle to a tool finishing element may also reduce or eliminate stress points that exist where rivets, screws, welds, or other fasteners were previously applied to attach the handle, handle bracket, or intermediate plate.

The adhesives used on the double-sided tape may, for example, include acrylic, urethane, or various structural adhesives that offer good shear strength and high tensile and peel strengths. Most double-sided tape adhesives bond quickly at room temperature at the time the surfaces are pressed together with the tape between the surfaces so that minimal or no time or staging area or special devices such as heating elements may be required after assembly. Alternately, whether assembly is performed in a colder than room temperature facility or a temperature above room temperature is desired, heat may be applied to the assembly or a component of the assembly.

A surface may be textured or short holes that do not extend through the part being attached by double-sided tape 50 may be placed in a surface to increase surface area to improve adhesion to the double-sided tape 50.

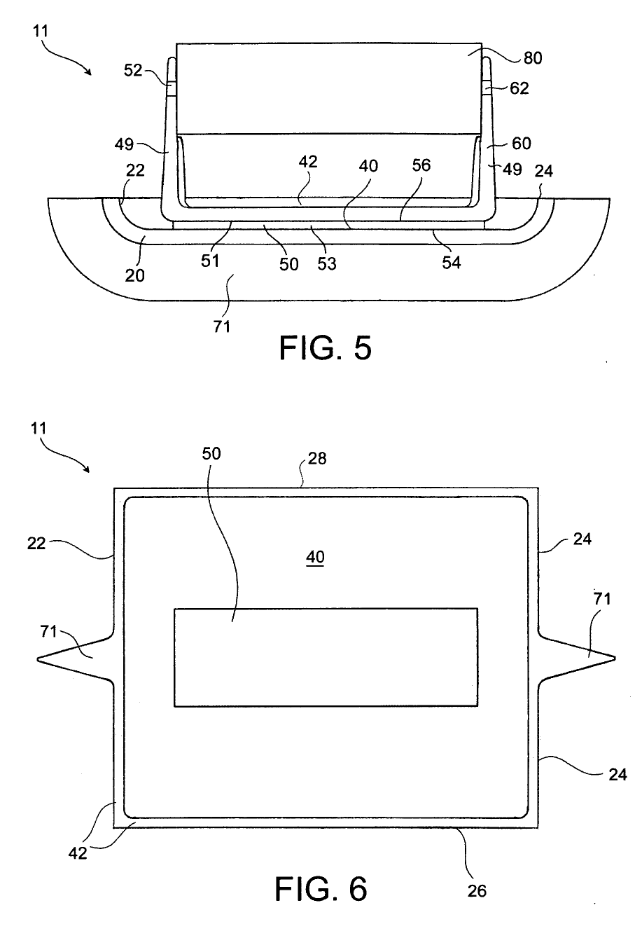

FIGS. 5 and 6 illustrate views of another embodiment of a groover 11 in which a bit 71 extends past both the front edge 22 and the back edge 24, and is rounded at both ends to facilitate bi-directional operation. FIG. 5 is a sectional side view of the groover 11 cut along the length of the bit 71 with double-sided tape 50 attaching the handle bracket 49 to the top face 40 of the groover body 20. FIG. 6 is a top view of the groover 11 with double-sided tape 50 applied to a top face 40 of the body 20 prior to attachment of the handle bracket 49 and the handle 80. In such a configuration, the bit 71 may extend past both the front and back edges 22 and 24 of the body 20 symmetrically or asymmetrically as desired.

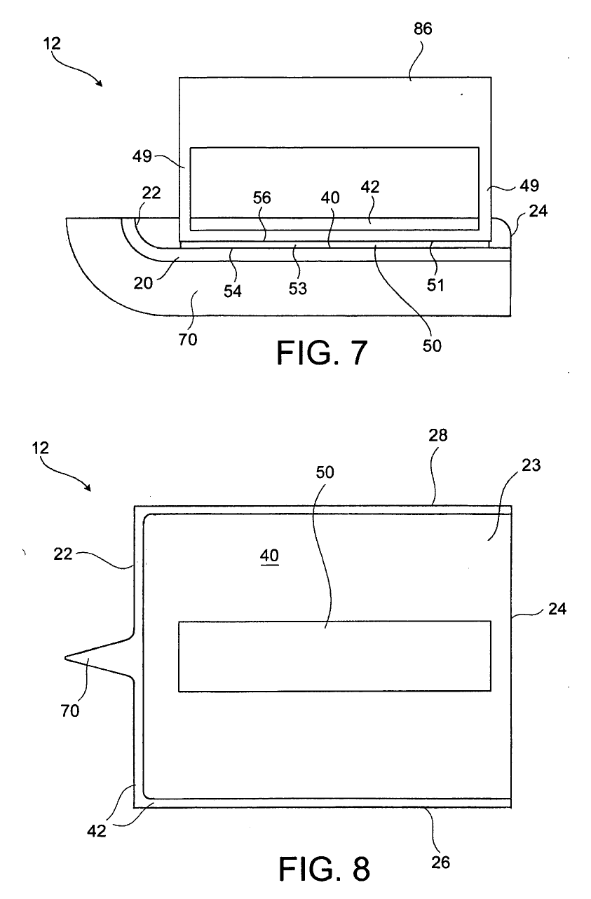

FIGS. 7 and 8 depict a groover 12 having a handle 86 formed with its bracket 49 that is taped to a groover body 20 finishing element. FIG. 7 is a sectional side view of the groover 12 cut along the length of a bit 70 with double-sided tape 50 attaching the handle 86 and handle bracket 49 to the top face 40 of the groover body 20. FIG. 8 is a top view of the groover 12 with double-sided tape 50 applied to a top face 40 of the body 20 prior to attachment of the handle bracket 49 and the handle 86.

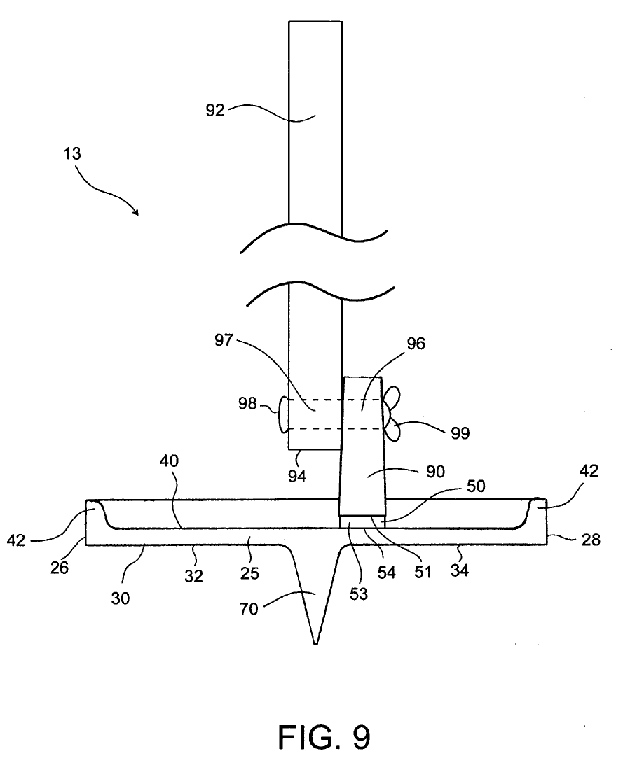

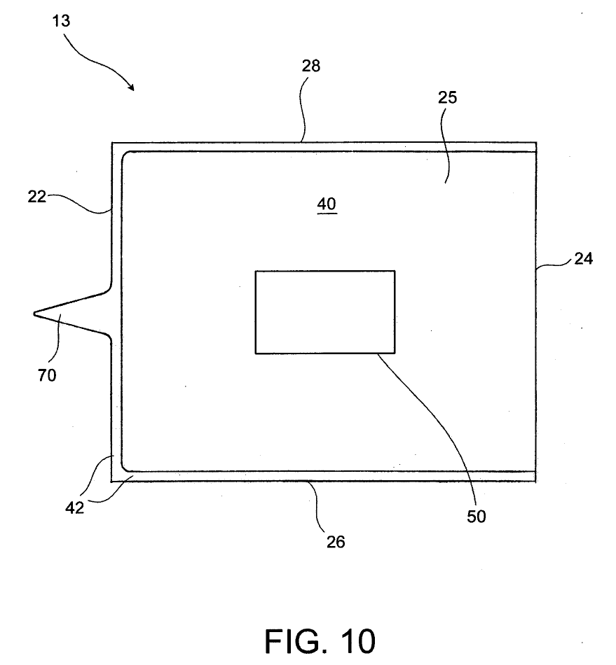

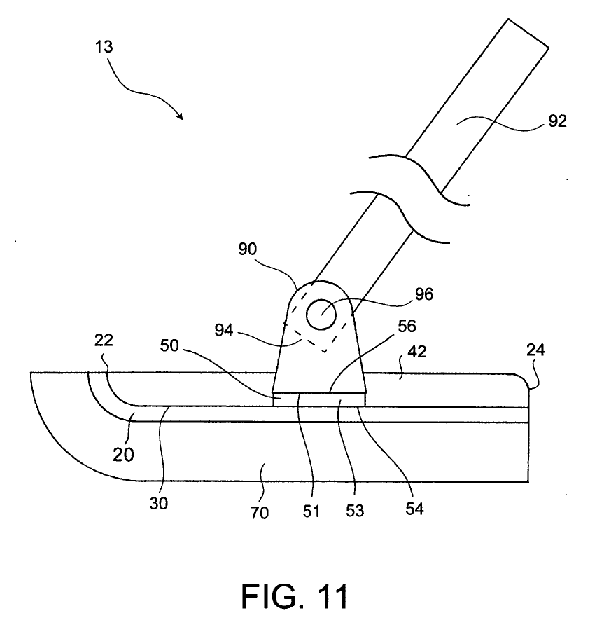

FIGS. 9-11 illustrate a groover 13 having a detachable extension handle 92. FIG. 9 is a rear view of the groover 13 with a handle bracket 90 taped to the top face 40 of the groover 13 and having the extension handle 92 attached to the handle bracket 90. FIG. 10 is a top view of the groover of FIG. 9 prior to attachment of the handle bracket 90 and FIG. 11 is a sectional side view of the groover of FIGS. 9 and 10. The groover 13 includes a handle support bracket 90, taped to the top face 40 of the body 25 using double-sided tape 50 as described herein. The bracket 90 may also be fastened to one end 94 of an extension handle 92. As may be seen with reference to FIG. 9, the extension handle 92 may be fastened to the handle support bracket 90 by aligning a bracket aperture 96 in the bracket 90 with a handle aperture 97 in the extension handle 92 and placing a bolt 98 or other fastener therethrough. Where a bolt 98 is used to fasten the extension handle 92 to the bracket 90, a locking wing nut 99 or other type of nut may be threaded onto the bolt 98 where the bolt 98 extends through the bracket aperture 96 and the handle aperture 97. Other fasteners may be used as desired to connect the extension handle 92 to the bracket 90, fixedly, pivotally, or otherwise, including an extension handle (not shown) having a head on one end and a hole near its other end through which a cotter pin may be placed.

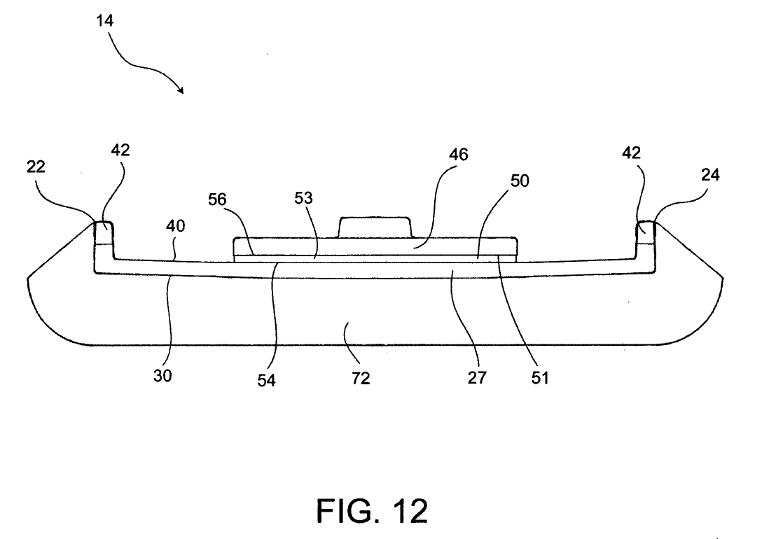

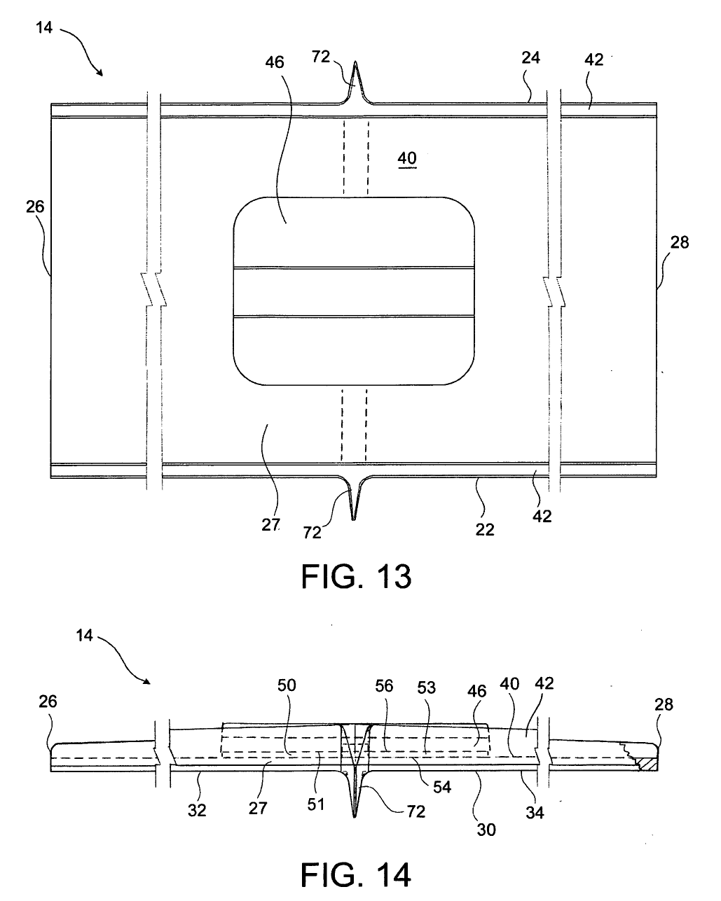

FIGS. 12-14 illustrate an embodiment of a “flying” groover 14. FIG. 12 depicts a side view of the flying groover 14, FIG. 13 illustrates a top view of the flying groover 14, and FIG. 14 illustrates a front view of the flying groover 14. The body 27 of the flying groover 14 may be wider than the bodies of other embodiments, i.e., the body 27 may be greater distanced between its first side 26 and second side 28 than the groover 10 illustrated in FIGS. 1-4. The flying groover 14 depicted in FIGS. 12-14 includes a handle bracket 46 to which a handle (not shown) or a second portion of the handle bracket (not shown) may be coupled. This handle bracket 46 is affixed to the top face 40 of the body 27 of the flying groover 14 by double-sided tape 50 as described herein.

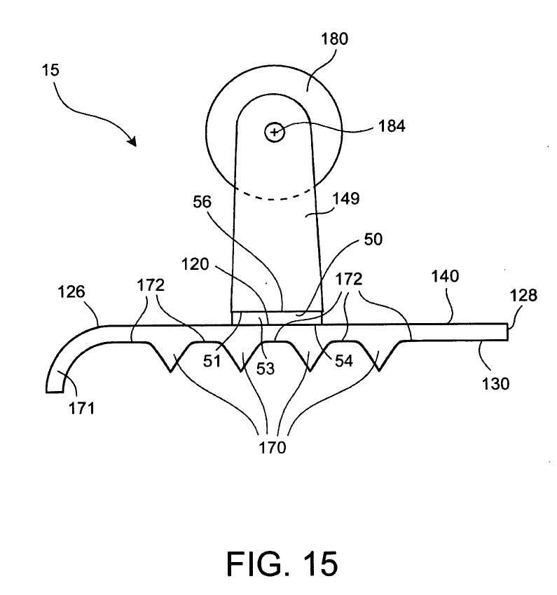

FIG. 15 shows another embodiment of a concrete-finishing tool. In this embodiment, the body 120 of the concrete-finishing tool 15 includes multiple concrete-shaping elements, including bits 170 for grooving and a lip 171 for edging. Any number and combination of bits 170 and lips 171 may be included, as desired. The bits 170 may be disposed between the guiding portions 172 of the bottom face 130. The bits 170 may project from the bottom face 130 at an angle substantially perpendicular to the plane that may be defined by the guiding portions 172, or at another angle as desired.

The body 120 of the concrete-finishing tool illustrated in FIG. 15 may include a handle support 149 that is affixed to the top face 140 of the body 120 by double-sided tape 50 as described herein. A handle 180 may be attached to the handle support 149 as described in the embodiments above. Alternatively, the handle support 149 may include a bracket 90 for fastening to an end 94 of a handle, such as the extension handle 92, as described with respect to embodiments described herein, or another handle support and handle combination.

The lip 171 may be an edging element and may further be curved and project from the bottom face 130 and/or a side, such as the first side 126, at a desired angle or angles, as shown in FIG. 15. The lip 171 may alternatively be shaped as a straight or flat element or otherwise as function dictates. Double-sided tape 50 may be used in many edgers designs and examples of certain of those other designs for edging elements are described with respect to the edgers discussed below.

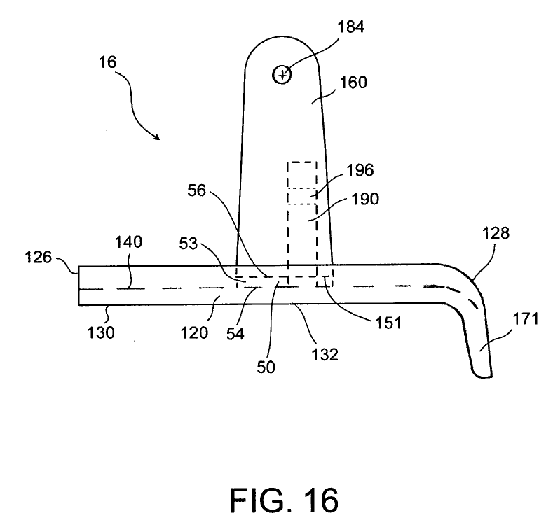

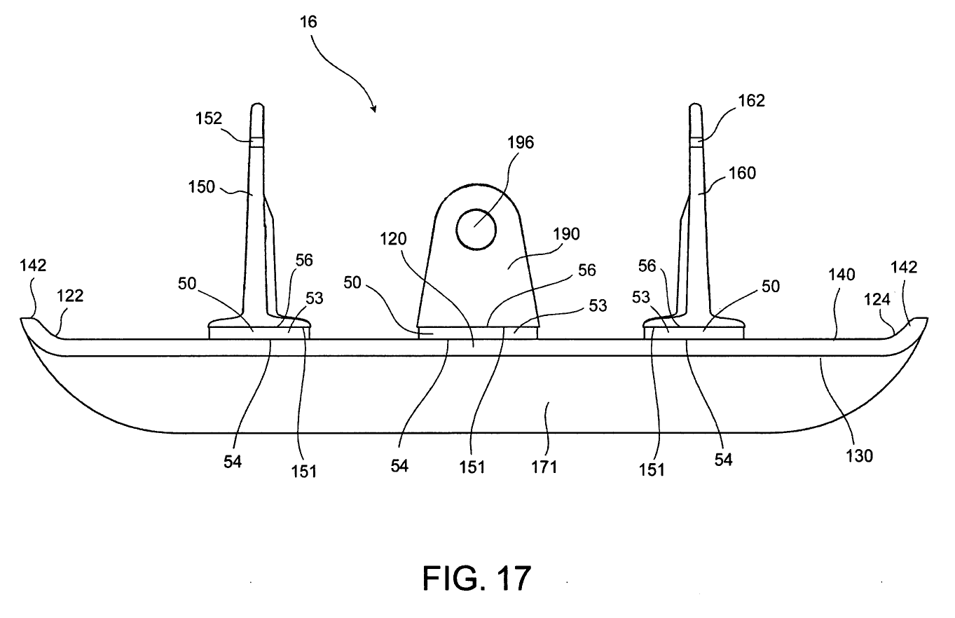

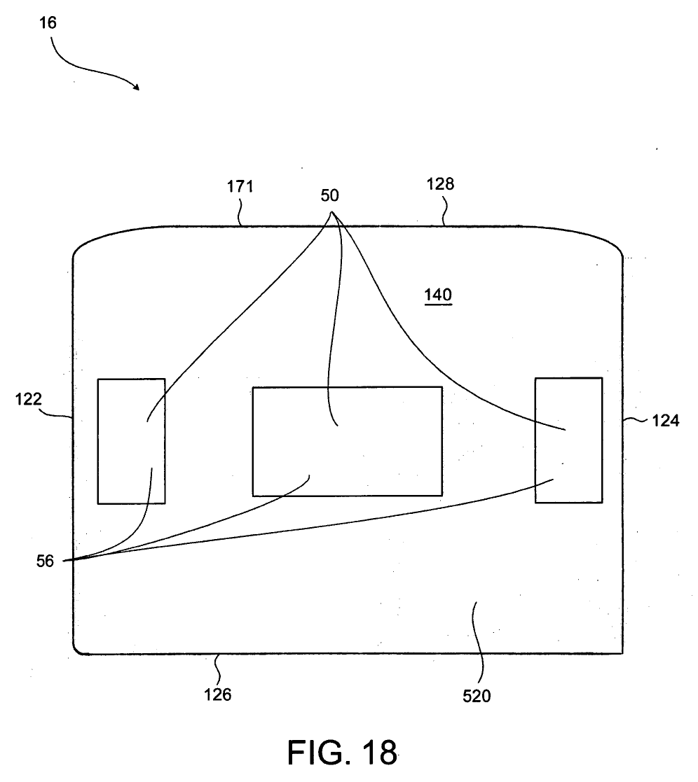

FIGS. 16-18 illustrate an embodiment of an edger 16 that includes a finishing element, here a lip 171 for edging and three handle brackets 150, 160, and 190 taped to the finishing element as described herein. FIG. 16 is a front view of the edger 16 showing two of the handle brackets 160 and 190 attached to the edger body 120 at their finishing element surfaces 151 by double-sided tape 50. FIG. 17 is a sectional side view of the edger 16 of FIG. 16 with the handle brackets 150, 160, and 190 attached to the edger body 120 by double-sided tape 50. FIG. 18 is a top view of the edger 16 of FIGS. 16 and 17 with three pieces of double-sided tape 50 attached to the top face 140 of the edger body 120, prior to attachment of the handle brackets 150, 160, and 190. The handle brackets 150, 160, and 190 may alternately be any type of handle bracket described herein or that may otherwise be desired. A handle, such as the handle 80 illustrated in FIGS. 1-4, may be attached to the handle brackets 150 and 160, and a handle, such as handle 92 illustrated in FIGS. 9-11, may be attached to the handle bracket 190, or another handle may be attached to any one or combination of the handle brackets 150, 160, and 190 as desired.

The lip 171 may be formed on the bottom face 130 of the body 120. The body 120 may include a front edge 122 and a back edge 124, a first side 126 and a second side 128, and a bottom face 130 and a top face 140. The body 120 may further include a guiding portion 132 disposed on the bottom face 30, for guiding the edger 16 along concrete during operation. The guiding portion 132 may be generally flat, or another shape if desired. The top face 140 may include a projecting portion 142 that extends along the front edge 122 and the back edge 124. The top face 140 and the bottom face 130 may be flat and parallel, or shaped differently.

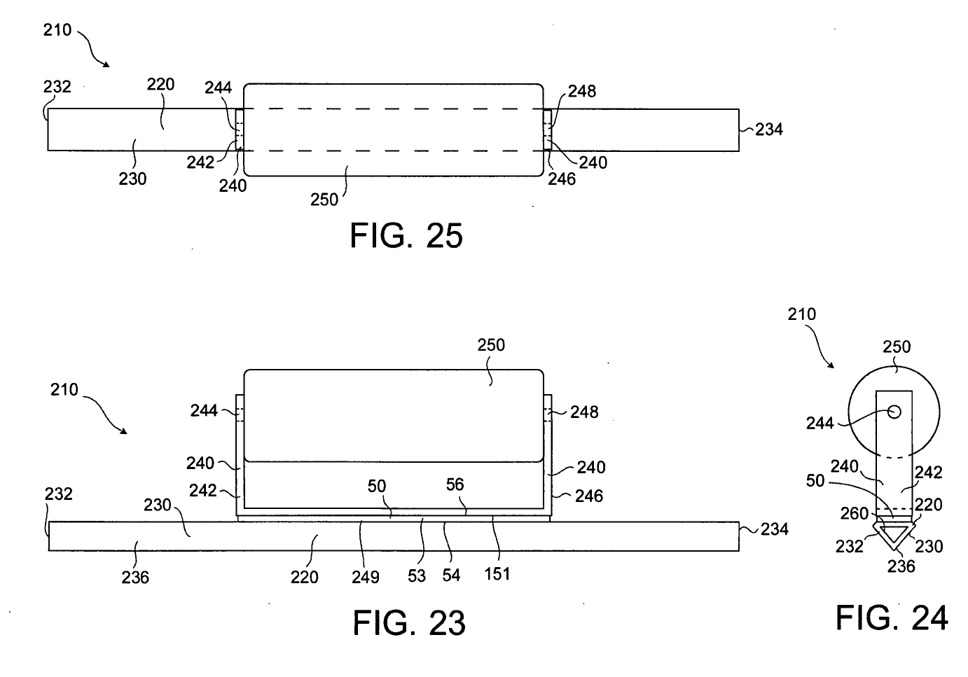

The edging element, lip 171, may extend from the front edge 122 to the back edge 124 of the body 120, along the second side 128 of the body 120. Viewed from the perspective of FIG. 23, the lip 171 may be curved and project from the bottom face 130, as well as from the second side 128, at a desired angle or angles. The lip 171 may alternatively be shaped as a straight or flat element or otherwise as function dictates.

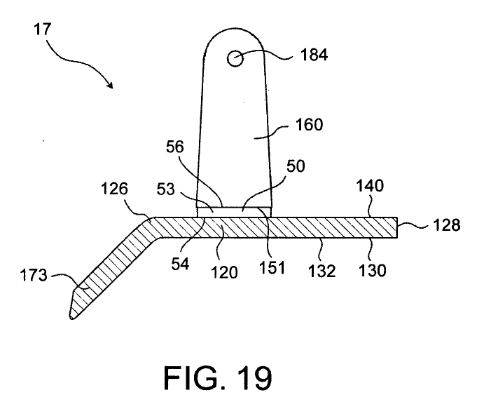

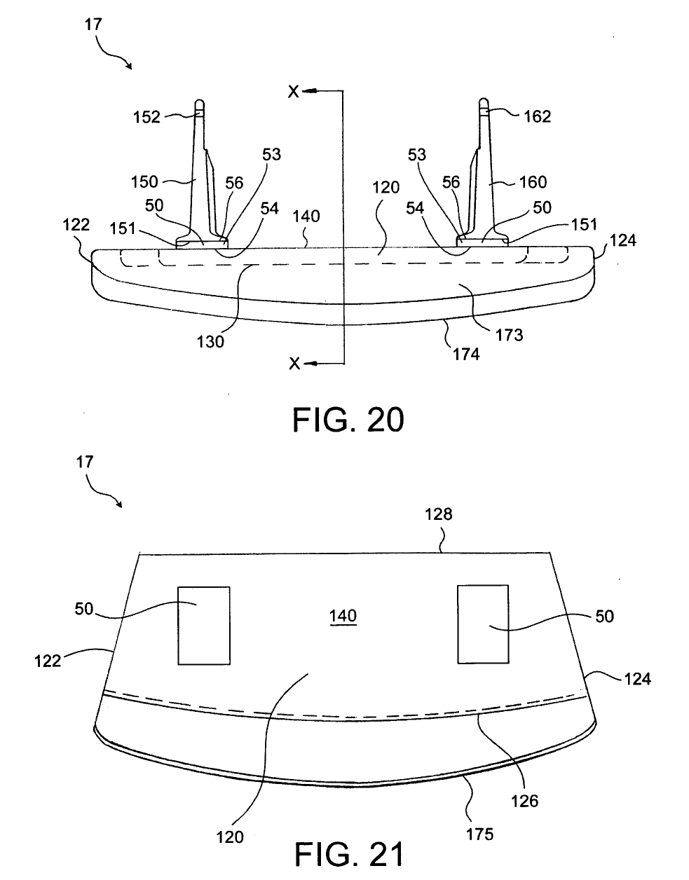

FIGS. 19-21 illustrate another embodiment of an edger 17 having another handle bracket configuration taped to the top face 140 of the finishing element and providing another shape for an edging lip. FIG. 19 is a front view of the edger 17 showing one of the handle brackets 160, which is attached to the edger body 120 by double-sided tape 50. FIG. 20 is a sectional side view of the edger 17 with the handle brackets 150 and 160 attached to the edger body 120 by double-sided tape 50. FIG. 21 is a top view of the edger 171 with three pieces of double-sided tape 50 attached to the top face 140 of the edger body 120, prior to attachment of the handle brackets 150 and 160. The handle brackets may alternately be any type of handle bracket described herein or that may otherwise be desired. A handle, such as the handle 80 illustrated in FIGS. 1-4 may be attached to the handle brackets 150 and 160 or another handle may be attached to any one or both of the handle brackets 150 and 160 as desired.

In the edger embodiment illustrated in FIGS. 19-21, the lip 173 of the body 120 may be formed adjacent the guiding portion 132. The lip 173 may project from the bottom face 130, as well as projecting from the second side 128. The lip 173 may be curved at both its bottom surface 174, as shown from the perspective of FIG. 20, and at its outer surface 175, as shown from the perspective of FIG. 21. This lip configuration may be used to round an edge of a concrete slab.

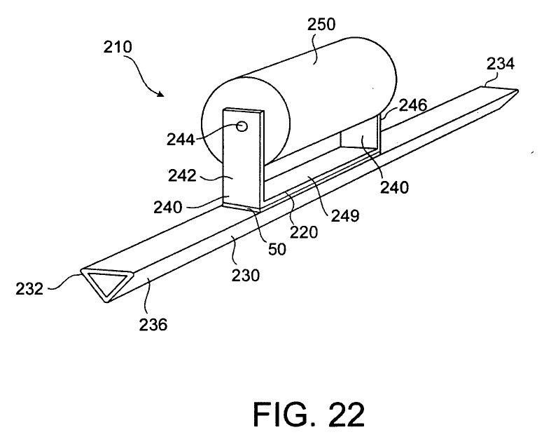

FIGS. 22-25 illustrate a mortar joint finishing tool 210 assembled using double-sided tape 50. FIG. 22 depicts an isometric view of the mortar joint finishing tool 210, which may be a type of mortar joint finishing tool generally referred to as a sledrunner. FIG. 23 is a side view of the mortar joint finishing tool 210, FIG. 24 is an end view of the mortar joint finishing tool 210, and FIG. 25 is a top view of the mortar joint finishing tool 210.

The mortar joint finishing tool 210 illustrated includes a body 220 that includes a mortar-contacting element 230 having a first end 232, a second end 234, and an outer surface 236, and a handle bracket 240, a first upright 242, a second upright 246, and a base 249 similar to the handle bracket 49 illustrated in FIGS. 1-4. The first upright 242 may include an aperture 244 and the second upright 246 may include an aperture 248 through which fasteners may be inserted to attach a handle 250. The handle bracket 240 may be affixed to the body 220 by placing double-sided tape 50 between the handle bracket 240 and the body 220.

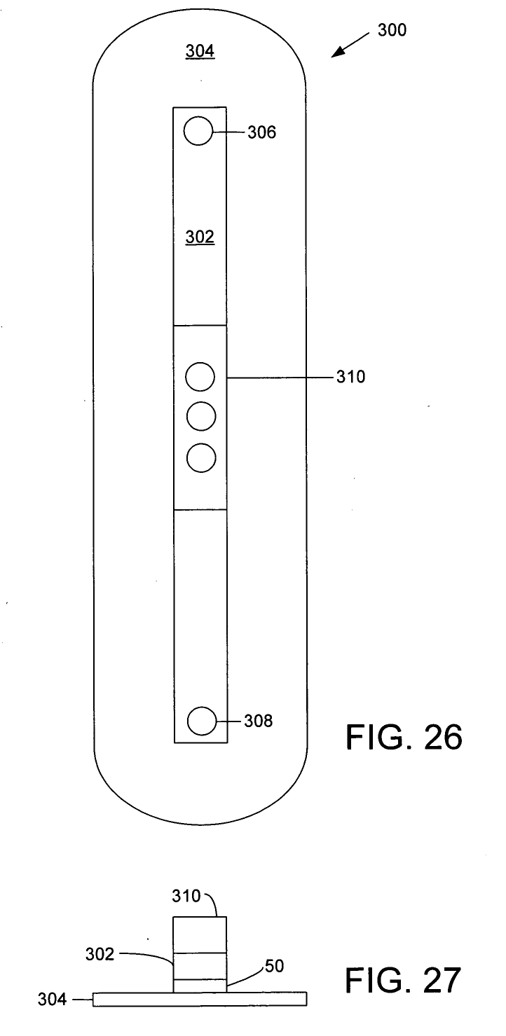

FIGS. 26 and 27 depict a trowel 300, which may be the type of trowel often referred to as a Fresno trowel. FIG. 26 is a top view of the Fresno trowel 300 with a handle bracket 302 affixed thereto by double-sided tape. FIG. 27 is an end view of the Fresno trowel 300. It should be recognized that a combination of double-sided tape 50 and rivets, screws, welds, or other fasteners may be used together where the properties of both double-sided tape 50 and the other fastener are desired. For example, the trowel 300 depicted in FIGS. 26 and 27 includes the handle bracket 302 that may be taped to a top surface 304 of the trowel 300. Rivets 306 and 308 are placed near each end of the handle bracket 302 in this embodiment to provide additional fastening strength. A handle, such as the extension handle 92 depicted in FIGS. 9-11, may be attached to the handle bracket 302 at an attachment area 310. That configuration may provide improved strength and also substantially reduce the number of rivets applied from previous all riveted Fresno trowels 300.

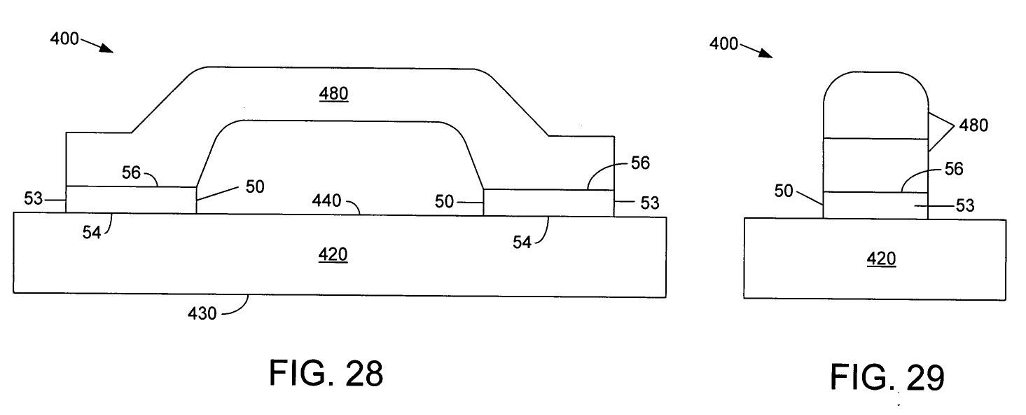

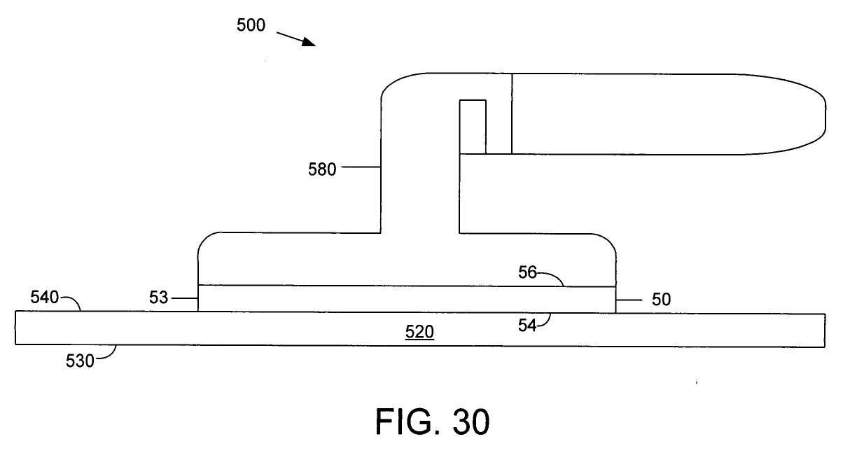

FIG. 28 is a side view of a float 400 assembled using tape 50 and FIG. 29 is an end view of that float 400. The float 400 includes a body 420 having a bottom face 430 operating surface and a top face 440 handle coupling surface. A handle, 480 is attached to the top face 440 handle coupling surface of the float 400 by way of double-sided tape 50, as has been described herein.

FIG. 30 is a side view of another trowel 500 having a handle 580 attached thereto using tape 50. The trowel 500 includes a body 520 having a bottom face 530 operating surface and a top face 540 handle coupling surface. The handle, 580 is attached to the top face 540 handle coupling surface of the trowel 500 by way of double-sided tape 50, as has been described herein.

The foregoing description has been directed to specific embodiments of this invention. It will be apparent, however, that other variations and modifications may be made to the described embodiments, with the attainment of some or all of their advantages. For example, double-sided tape may be used to bond handles to finishing elements on many hand tools including a variety of masonry tools. Double-sided tape may also be used to bond portions of power tools such as the various components of a power trowel blade. Various handle brackets may also be affixed to finishing elements including detachable handles, variable angle handles, and pivoting handles, for example. Furthermore, the handle may be coupled to the finishing element directly, through the use of an intermediate plate, or through the use of a bracket.

It will also be appreciated that features described with respect to one embodiment may be applied to another, whether explicitly indicated. Therefore, it is the object of the appended claims to cover all such variations and modifications as come within the true spirit and scope of the invention.

What is claimed is:

1. A hand tool comprising a finishing element and a handle, the finishing element affixed to the handle with a first adhesive tape.

2. The hand tool of claim 1, wherein the first adhesive tape is double-sided adhesive tape.

3. The hand tool of claim 1, wherein the hand tool is a masonry tool.

4. The hand tool of claim 1, wherein the construction tool is a concrete-finishing tool.

5. The hand tool of claim 4, wherein the concrete-finishing tool is a trowel.

6. The hand tool of claim 4, wherein the concrete-finishing tool is a groover.

7. The hand tool of claim 4, wherein the concrete-finishing tool is an edger.

8. The hand tool of claim 4, wherein the concrete-finishing tool is a float.

9. The hand tool of claim 1, wherein the finishing element comprises at least two parts, and wherein the two parts are affixed together with a second adhesive tape.

10. The hand tool of claim 1, wherein the handle further comprises:
a handle bracket affixed to the finishing element by double-sided tape; and
a handle coupled to the handle bracket.

11. The hand tool of claim 10, wherein the handle is coupled to the handle bracket by double-sided-tape.

12. The hand tool of claim 1, further comprising an intermediate plate wherein the intermediate plate is affixed to the finishing element by double-sided tape and the handle is affixed to the intermediate plate.

13. The hand tool of claim 1, further comprising an intermediate plate wherein the intermediate plate is affixed to the handle by double-sided tape and the finishing element is affixed to the intermediate plate.

14. A construction tool comprising:
a finishing element; and
a handle bracket affixed to the finishing element by adhesive tape.

15. The construction tool of claim 14, further comprising a handle attached to the handle bracket.

16. The construction tool of claim 15, wherein the handle includes a handle post.

17. The construction tool of claim 15, wherein the handle is affixed to the handle bracket by a second piece of adhesive tape.

18. A method of affixing two members comprising a tool, the method comprising:
applying a first side of a double-sided tape to the first member;
affixing the second member to the second side of the double-sided tape forming an assembly of the first and second members; and
applying pressure to the assembly.

19. The method of claim 18, further comprising cleaning at least one of the first and second members prior to applying the double-sided tape thereto.

20. The method of claim 18, further comprising removing a coating from the double-sided tape prior to affixing the second member to the double-sided tape.

21. The method of claim 18, wherein the first member is a finishing element and the second member is a handle.

22. The method of claim 18, wherein the first member is a finishing element and the second member is a handle bracket.
